(19) United States
(12) Patent Application Publication
(10) Pub. No.: US 2006/0121761 A1
(43) Pub. Date: Jun. 8, 2006

(54) High-amperage electrical bushing connector

(76) Inventors: Mehdi Chaabane, Marly le Roi (FR); Marc Jarnier, Levallois Perret (FR)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/535,798

(22) PCT Filed: Nov. 20, 2003
(86) PCT No.: PCT/FR03/50128

§ 371 Date: Jan. 6, 2006

(51) Int. Cl. H01R 13/52

(52) U.S. Cl. 439/274

(57) ABSTRACT

The invention relates to a connector (10) for high amperage electric crossing (11) including at least one pin (12) having a first main axis (13). The connector (10) comprises a first assembly including a socket (15) having a second main axis (16) and a first insulator (21) intended to cover at least partially the socket (15). According to the invention, the first assembly comprises a cap (22) including a recess centred (23) on the second main axis (16) of the socket (15) and locking means (24) to attach the cap (22) to the first insulator (21). The connector (10) comprises moreover a second assembly including a second insulator (28) and fastening means (29) to attach the second insulator (28) to the electric crossing (11), said second insulator (28) surrounding said pin (12) and including at least one recess centred on the first main axis (13) to receive the first insulator (21) when inserting the socket (15) into the pin (12).

This invention relates to a connector for high amperage electric crossing.

One of the current techniques used for preparing layers under ultra-high-vacuum is called Molecular Beam Epitaxy (MBE). Such technique enables to provide epitaxial layers by carrying a material, containing the constituents of the layer to be formed, to a metallic or semi-conductor substrate, where it is adsorbed. Such transport of material is performed in a vacuum chamber and preferably a chamber under ultra-high-vacuum, i.e. at a pressure lower than 10⁻⁹ mbar in order to obtain films exempt from any contamination.

The most current source of material for conducting this Molecular beam epitaxy is evaporation from a Knudsen-type source. It is then a crucible heated by a Joule effect which may be made of boron nitride or of high purity graphite, for example, with a cylindrical or conical shape.

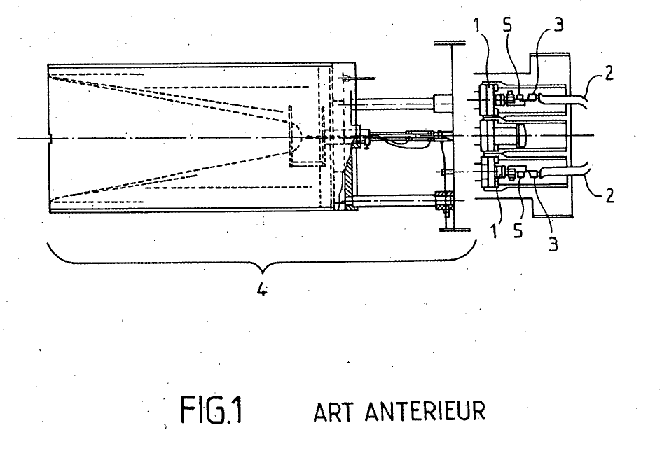

The Joule effect is generally obtained by using a resistive element, for example a filament. To evaporate certain materials, temperatures in excess of 1000° C. are necessary, which implies injecting into the resistive element a high intensity current. A chain of appropriate elements is therefore necessary to deliver the current required to the resistive element. High amperage electric crossings 1 for instance at least of the order of 50 A are thus implemented to establish a link between the resistive elements situated inside the vacuum chamber and outside the chamber where are placed the generators (FIG. 1). Electric cables 2 of appropriate cross-section, for instance, 10 mm² for a current I ranging between 35 and 50 A, provide a link between such generators and the electric crossings 1. Copper lug electric connections 3 are used to provide the connection between the high amperage electric crossings and the power supply cables 2.

However, this type of connection does not allow easy manipulation of the power supply cables 2. Thus, assembling and disassembling power supply cables 2, for instance to change a cell, implies tightening/loosening screws 5 at the lug 3. The electric crossing 1 is then subjected to torsions liable to result into a loss of tightness of said crossing 1. Moreover, any action on the lug electric fittings 3 involves an electric safety problem for the user since this manipulation requires removing possible electric insulations.

The aim of this invention is to provide a connector for high amperage electric crossing, simple in its design and economical, being an excellent conductor while allowing easy manipulation of the power supply cables as well as high protection for the user.

In this view, the invention relates to a connector for high amperage electric crossing including at least one pin having a first main axis, comprising a first assembly including a socket having a second main axis, said socket being intended to be attached to an electric cable, and a first insulator intended to cover at least partially the socket.

According to the invention,

the first assembly comprises a cap including a recess centred on the second main axis of the socket and locking means to attach the cap to the first insulator, said cap then covering partially said insulator, and

the connector comprises a second assembly including a second insulator and fastening means to attach the second insulator to the electric crossing, said second insulator surrounding said pin and including at least one recess centred on the first main axis to receive the first insulator when inserting the socket into the pin.

In various embodiments, this invention also relates to the following features which will be considered individually or in all their technically possible combinations:

he first and second insulators and the cap are made of a rigid and electrically insulating plastic material,

said material is polyether ether ketone,

the cap comprises a cylindrical recess facing the first insulator,

the locking means comprise a flat head screw,

the fastening means comprise bolts,

the external lateral faces of the first insulator and the internal faces of the cap and of the second insulator are at least partially threaded in order to screw said cap to the first insulator on the one hand and the first insulator to the second insulator on the other.

In various possible embodiments, the invention will be described in more detail with reference to the appended drawings wherein:

FIG. 1 is a diagrammatical representation of a power supply chain including a copper lug electric fitting for a high intensity electric crossing of the prior art;

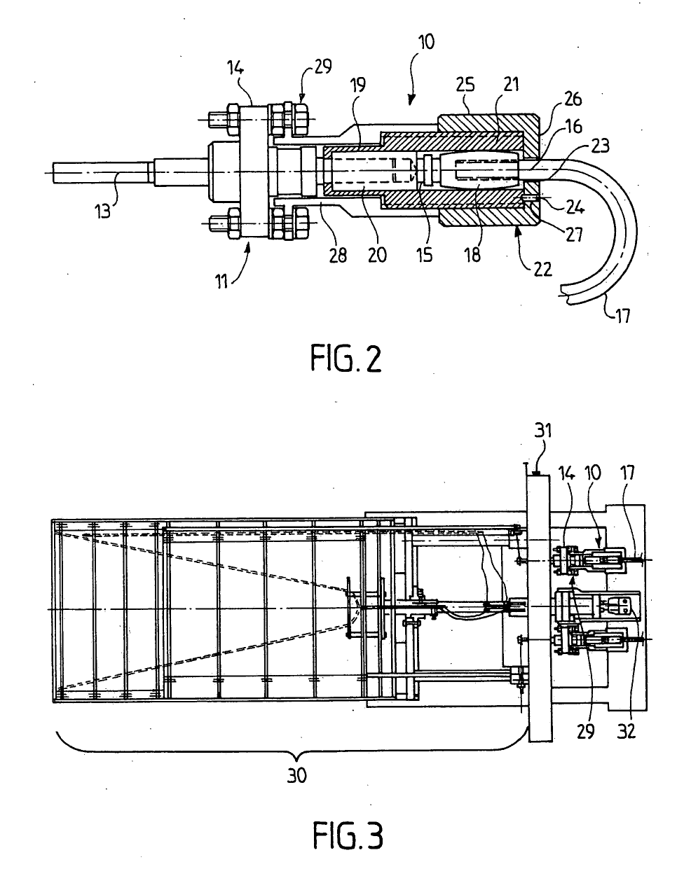

FIG. 2 is a diagrammatical representation of a connector for high amperage electric crossing, according to the invention;

FIG. 3 is a diagrammatical representation of a chain of element for power supplying a resistive element in a crucible including a connector, according to an embodiment of the invention.

An object of this invention is the realisation of a connector 10 to link electrically a power supply cable to high amperage electric crossing 11. These crossings 11 are well-known and enable the realisation of electric connections between elements placed in a closed volume and a generator situated outside this volume. Such electric crossing 11 includes at least one pin 12 having a first main axis 13 and of diameter d. According to an embodiment, said pin 12 is soldered to a flange 14 in order to be mounted on a vacuum system. However, the connector 10 according to the invention is not limited to this single realisation and addresses high amperage electric crossings 11 in general.

With reference to FIG. 2, the connector 10 comprises a first assembly including a socket 15 having a second main axis 16. Such socket 15 is intended to be attached, typically crimped, to an electric cable 17. It comprises moreover a portion 19 including a recess 20 centred on the second main axis 16 and of diameter d intended to surround the pin 12 of the electric crossing 11 when electric connection is established between said cable 17 and said crossing 11. Such socket 15 is made of a material which is very well conductive and with little contact resistance, preferably of high quality copper, silver. Said first assembly also comprises a first insulator 21 intended to cover at least partially the socket 15.

According to a preferred embodiment, said insulator 21 covers the socket 15 totally with the exception of said recesses 18, 20 used for receiving the pin 12 or the power supply cable 17.

The first assembly comprises moreover a cap 22 including a first recess 23 centred on the second main axis 16 of the socket and locking means 24 to attach the cap 22 to the first insulator 21. By [symbol] cap [symbol] is meant therein a part of insulating material including a wall 25 integral with a bottom 26. The internal diameter D of this part is at least equal to the external diameter of the first insulator 21 so that after fastening the cap 22 to the first insulator 21, the latter then covers partially said insulator.

Advantageously, the cap 22 comprises a second cylindrical recess 27 facing the first insulator 21 and the locking means 24 then comprise a flat head screw. The cap 22 is thus pressed to the flat head screw on the external face of the first insulator.

A method for mounting the first assembly will be described. Before crimping the socket 15 on the power supply cable 17, said cable is run through the first recess 23 of the cap 22. Once the socket 15 has been crimped, the cap 22 is attached to the first insulator 21 covering the socket 15 and is locked after screwing the locking means 24.

The connector comprises a second assembly including a second insulator 28 and fastening means 29 to attach the second insulator to the electric crossing. These fastening means 29 comprise for instance bolts.

The second insulator 28 surrounds the pin 12 and includes at least a recess centred on the first main axis 13 whereof the internal diameter d′ is such that it surrounds the first insulator 21 up to the cap 22 after inserting the socket 15 into the pin 12.

In a preferred embodiment, the first and second insulators 21, 28 and the cap 22 are made of a rigid and electrically insulating plastic material such as polyether ether ketone (PEEK) or a polyimide such as VESPEL or other.

According to an embodiment, the external lateral faces of the first insulator 21 and the internal faces of the cap 22 and of the second insulator 28 are at least partially threaded. When assembling the connector, the cap 22 is screwed to the first insulator 21 covering thus partially said insulator 21. And the latter, when connecting the power supply cable 17 to the electric crossing 11 is itself screwed on the second insulator 28 enabling advantageously an integral connection.

In another embodiment, the internal diameter D of the cap 22 is smaller than the external diameter of the first insulator 21 so that the cap 22 is embossed into said first insulator 21.

The internal diameter d′ of the second insulator 28 is equal to or smaller than the external diameter of the first insulator 21 so that the first assembly may be inserted into or withdrawn freely from the second assembly.

FIG. 3 shows an embodiment of this invention wherein the connector establishes an electric connection on an effusion source 30. The flange 31 also includes temperature reading 32 via a thermocouple crossing.

The fastening means 29 to attach the second insulator 28 to the electric crossing 11 comprise the screws and the bolts enabling to attach the flange 14 of the high amperage electric crossing 11 to the supporting flange of the effusion source 30.

Such connector may be used advantageously for any system requiring the injection of a high intensity current and therefore the use of a high amperage crossing. Advantageously, the insulators made of polyether ether ketone exhibit good temperature handling (250° C. over more than 20,000 hours) and the connectors according to the invention may be employed on systems subjected to high temperatures.

1. A connector for high amperage electric crossing (11) of a vacuum chamber including at least one pin (12) having a first main axis (13), comprising a first assembly including a socket (15) having a second main axis (16), said socket (15) being intended to be attached to an electric cable (17), and a first insulator (21) intended to cover at least partially the socket (15),
and a connector (10) comprising a second assembly including a second insulator (28) and fastening means (29) to attach the second insulator (28) to the electric crossing (11), said second insulator (28) surrounding said pin (15) and including at least a recess centred on the first main axis (13) to receive the first insulator (21) when the connector is connected to the electric crossing (11), the pin (12) is inserted into the socket (15), the first assembly comprises a cap (22) including a recess (23) centred on the second main axis (16) of the socket (15), characterised in that said cap (22) comprises locking means (24) including a flat head screw allowing to attach said cap (22) on the extern face of said first insulator (21) by pressure, said cap (22) then covering partially said insulator (21).

2. A connector for high amperage electric crossing according to claim 1 characterised in that the first and second insulators (21, 28) and the cap (22) are made of a rigid and electrically insulating plastic material.

3. A connector for high amperage electric crossing according to claim 2 characterised in that said material is polyether ether ketone.

4. Connector for high amperage electric crossing according to claim 1, characterised in that the cap (22) comprises a cylindrical recess (27) facing the first insulator (21).

5. A connector for high amperage electric crossing according to claims 1 to 4, characterised in that the fastening means (29) comprise bolts.

6. A connector for high amperage electric crossing according to any of the claims 1 to 5, characterised in that the external lateral faces of the first insulator (21) and the internal faces of the cap (22) and of the second insulator (28) are at least partially threaded in order to screw said cap (22) to the first insulator (21) on the one hand the first insulator (21) and to the second insulator (28) on the other.

7. (canceled)
